(19) United States
(12) Patent Application Publication
(10) Pub. No.: US 2013/0217434 A1
(43) Pub. Date: Aug. 22, 2013

(54) METHOD AND SYSTEM FOR TRANSMITTING DATA AND ELECTRONIC APPARATUS USING THE METHOD

(71) Applicants: Shih-Cheng Chou, Taipei City (TW); Shun-Lee Chang, Taipei City (TW); Pi-Feng Shih, Taipei City (TW); Yung-Liang Miao, Taipei City (TW)

(72) Inventors: Shih-Cheng Chou, Taipei City (TW); Shun-Lee Chang, Taipei City (TW); Pi-Feng Shih, Taipei City (TW); Yung-Liang Miao, Taipei City (TW)

(73) Assignee: COMPAL ELECTRONICS, INC., Taipei City (TW)

(21) Appl. No.: 13/762,341

(22) Filed: Feb. 7, 2013

Related U.S. Application Data
(60) Provisional application No. 61/662,898, filed on Jun. 21, 2012.
(60) Provisional application No. 61/601,003, filed on Feb. 20, 2012.

(51) Int. Cl. G06F 13/10; H04W 88/02

(52) U.S. Cl. CPC G06F 13/102; H04W 88/02
USPC 455/552.1; 455/557

(57) ABSTRACT

A method and a system for transmitting data and an electronic apparatus using the method are provided. The electronic apparatus is detachably coupled to an external apparatus. When the electronic apparatus performs data transmission with the external apparatus via a first transmission path, whether a state change signal is generated is checked. After the state change signal is generated, the follow-up data to be transmitted to the external apparatus is stored temporarily in a virtual storage interface. And, after a second transmission path is established between the electronic apparatus and the external apparatus, the data stored temporarily in the virtual storage interface is transmitted to the external apparatus via the second transmission path, so as to continue the data transmission with the external apparatus.

### CROSS-REFERENCE TO RELATED APPLICATION

This application claims the priority benefits of U.S. provisional application Ser. No. 61/601,003, filed on Feb. 20, 2012, and U.S. provisional application Ser. No. 61/662,898, filed on Jun. 21, 2012. The entirety of each of the above-mentioned patent applications is hereby incorporated by reference herein and made a part of specification.

### BACKGROUND OF THE INVENTION

1. Field of the Invention

The invention relates to a data transmission mechanism and particularly relates to a data transmission method and a data transmission system for preventing data from damage during transmission, and an electronic apparatus using the method.

2. Description of Related Art

To keep up with the bustling pace of the modern life, a variety of mobile devices which are readily portable and compact have flourished. Mobile devices are becoming lighter and thinner and are integrated with more and more functions. Since portability is a key feature of mobile devices, the sizes and weights of mobile devices are important to the consumers. That is, the current trend is to develop mobile devices to be lighter, thinner, smaller, and more efficient in power-saving.

In order to make mobile devices, such as tablet computers, mobile phones, or laptop computers, lighter and thinner, storage devices are usually removed from the mobile devices, and an external docking is used instead as the storage device. When a mobile device is integrated with the docking and transmitting data, separation of the mobile device and the docking will interrupt the data transmission and accordingly an error message will be shown on a display terminal. When the mobile device and the docking are integrated again, the user has to restart the transmission so as to complete the unfinished data transmission, which is a waste of time.

### SUMMARY OF THE INVENTION

The invention provides a data transmission method for preventing a data transmission between an electronic apparatus and an external apparatus from being interrupted or preventing data from being lost when the electronic apparatus and the external apparatus are separated or integrated.

The invention provides an electronic apparatus that predicts the separation of the electronic apparatus from an external apparatus, so as to switch a transmission path in advance.

The invention provides a data transmission system for preventing data from being damaged during transmission.

The invention provides a data transmission method adapted for an electronic apparatus detachably coupled to an external apparatus. According to the method, data transmission with the external apparatus is performed via a first transmission path, and whether a state change signal is generated is checked, so as to determine whether a connection state of the electronic apparatus and the external apparatus is about to change. After the state change signal is generated, data that is to be transmitted to the external apparatus is stored temporarily in a virtual storage interface and the first transmission path is interrupted. Moreover, the connection state of the electronic apparatus and the external apparatus is changed. A second transmission path is established between the electronic apparatus and the external apparatus. After the second transmission path is established, the data stored temporarily in the virtual storage interface is transmitted to the external apparatus via the second transmission path to continue the data transmission with the external apparatus.

Another data transmission method of the invention is adapted for an electronic apparatus that is detachably coupled to an external apparatus. The method includes: performing data transmission with the external apparatus via a wireless transmission path; checking whether a state change signal is generated to determine whether a connection state of the electronic apparatus and the external apparatus is about to change; changing the connection state of the electronic apparatus and the external apparatus after the state change signal is generated; establishing a wired transmission path between the electronic apparatus and the external apparatus; interrupting the wireless transmission path and storing data that is to be transmitted to the external apparatus temporarily in a virtual storage interface; and transmitting the data stored temporarily in the virtual storage interface to the external apparatus via the wired transmission path to continue the data transmission with the external apparatus.

The invention provides an electronic apparatus that includes a connection part, a detecting module, a virtual storage interface, and a processing unit. The connection part is detachably coupled to an external apparatus. The detecting module generates a state change signal responsive to whether a trigger component is enabled, so as to detect whether a connection state of the electronic apparatus and the external apparatus is changed. The virtual storage interface temporarily stores data that is to be transmitted to the external apparatus. The processing unit is coupled to the detecting module and the virtual storage interface. The processing unit performs data transmission with the external apparatus via a first transmission path. The processing unit stores the data that is to be transmitted to the external apparatus temporarily in the virtual storage interface when detecting that the state change signal is generated, and the processing unit transmits the data stored temporarily in the virtual storage interface to the external apparatus to continue the data transmission with the external apparatus via a second transmission path after the second transmission path is established with the external apparatus.

The invention provides a data transmission system that includes an electronic apparatus and an external apparatus. The electronic apparatus is detachably coupled to the external apparatus. The electronic apparatus includes a first connection part, a detecting module, a virtual storage interface, and a processing unit. The detecting module generates a state change signal responsive to whether a trigger component is enabled, so as to detect whether a connection state of the electronic apparatus and the external apparatus is changed. The virtual storage interface temporarily stores data that is to be transmitted to the external apparatus. The processing unit is coupled to the detecting module and the virtual storage interface, wherein the processing unit performs data transmission with the external apparatus via a first transmission path, and the processing unit stores the data that is to be transmitted to the external apparatus temporarily in the virtual storage interface when detecting that the state change signal is generated, and the processing unit transmits the data stored temporarily in the virtual storage interface to the external apparatus to continue the data transmission with the external apparatus via a second transmission path after the second transmission path is established with the external apparatus. The external apparatus includes a second connection part and a storage unit. The second connection part is detachably coupled to the first connection part. The storage unit stores the data received from the electronic apparatus.

Based on the above, according to the invention, a virtual storage interface is disposed in the electronic apparatus for temporarily storing the data that is to be transmitted when the connection between the electronic apparatus and the external apparatus is interrupted, and then transmitting the temporarily stored data to the external apparatus when the connection resumes, such that the user is not required to restart the transmission and can save time.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A and FIG. 1B are block diagrams illustrating a data transmission system according to the first embodiment of the invention.

FIG. 2 is a flowchart illustrating a data transmission method according to the first embodiment of the invention.

FIG. 3 is a diagram illustrating the switch of transmission paths according to the first embodiment of the invention.

FIG. 4A and FIG. 4B are block diagrams illustrating a data transmission system according to the second embodiment of the invention.

FIG. 5 is a flowchart illustrating an internal operation of an electronic apparatus when a state change signal is generated according to the second embodiment of the invention.

FIG. 6 is a flowchart illustrating a method for the electronic apparatus to request access to an external apparatus according to the second embodiment of the invention.

FIG. 7 is a block diagram illustrating the electronic apparatus and a cloud server according to the second embodiment of the invention.

FIG. 8A is a block diagram illustrating a data transmission system according to the third embodiment of the invention.

FIG. 8B is a diagram illustrating a structure of the electronic apparatus from a perspective of the user according to the third embodiment of the invention.

FIG. 9A and FIG. 9B are block diagrams illustrating a data transmission system according to the fourth embodiment of the invention.

### DESCRIPTION OF THE EMBODIMENTS

### First Embodiment

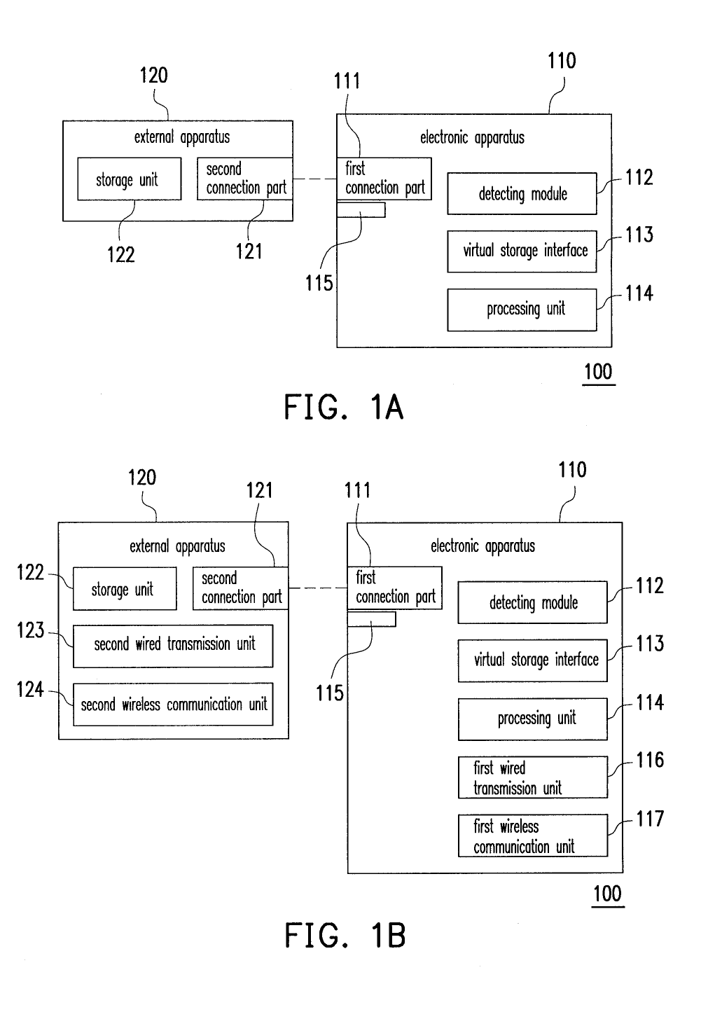

FIG. 1A and FIG. 1B are block diagrams illustrating a data transmission system according to the first embodiment of the invention. Referring to FIG. 1A, a data transmission system 100 includes an electronic apparatus 110 and an external apparatus 120. In this embodiment, the electronic apparatus 110 may be a mobile electronic apparatus, such as a tablet computer, a mobile phone, and a smart phone, etc. The external apparatus 120 is for example a docking having a storage unit 122 or another electronic apparatus; however, please note that the invention is not limited thereto. The electronic apparatus 110 at least includes a first connection part 111, a detecting module 112, a virtual storage interface 113, a processing unit 114, and a trigger component 115. The external apparatus 120 at least includes a second connection part 121 and a storage unit 122.

The electronic apparatus 110 is detachably coupled to the external apparatus 120 via the first connection part 111 and the second connection part 121. That is, the electronic apparatus 110 may be integrated with or separated from the external apparatus 120. Moreover, the detecting module 112 generates a state change signal responsive to whether the trigger component 115 is enabled, so as to detect whether a connection state of the electronic apparatus 110 and the external apparatus 120 is about to change, wherein the connection state may refer to a coupling state or a detaching state.

For example, in the case that the electronic apparatus 110 and the external apparatus 120 are integrated, before the first connection part 111 and the second connection part 121 are separated, the trigger component 115 needs to be enabled so as to detach the electronic apparatus 110 from the external apparatus 120. In this embodiment, the trigger component 115 may be a spring component. When the trigger component 115 is pressed, pulled, or pushed (not necessarily to the bottom), which means that the electronic apparatus 110 is to be detached from or integrated with the external apparatus 120, the detecting module 112 generates the state change signal.

In other embodiments, a detecting pin may be disposed in the detecting module 112. The detecting module 112 generates the state change signal when the trigger component 115 is pushed to the bottom to contact the detecting pin. Otherwise, the trigger component 115 may be a resistive component or a capacitive component and be coupled to the detecting module 112. Accordingly, the detecting module 112 generates the state change signal whenever the trigger component 115 is enabled. It is noted that the type of the trigger component 115 is not restricted to the above disclosure. According to different designs of the product, the trigger component 115 may also be a sensor configured for sensing whether the user approaches or touches the sensor. Specifically, the sensor may be a capacitive sensor or a proximity sensor. If the sensor is used as the trigger component 115, the detecting module 112 detects a change of a signal of the sensor and transmits a signal generated according to the change (i.e. the state change signal mentioned below) to the processing unit 114 for subsequent processes.

According to this embodiment, when the trigger component 115 is enabled, the detecting module 112 generates the state change signal and transmits the same to the processing unit 114. When the processing unit 114 receives the state change signal, a first transmission path is shut down, and a second transmission path is established. In addition, the virtual storage interface 113 is disposed in the electronic apparatus 110 for temporarily storing data that is to be transmitted to the external apparatus 120. For instance, the virtual storage interface 113 is established between an operation system of the electronic apparatus 110 and the external apparatus 120 for temporarily storing the data that is to be transmitted when a connection between the electronic apparatus 110 and the external apparatus 120 is interrupted. And, the data temporarily stored continues to be transmitted to the external apparatus 120 when the connection between the electronic apparatus 110 and the external apparatus 120 resumes. Specifically, the electronic apparatus 110 and the external apparatus 120 may be connected in a wired or wireless way. The virtual storage interface 113 is a buffer block divided from a physical storage block, which is a hard disk, a flash memory, a dynamic random access memory(DRAM), a static random access memory(SRAM), or a memory card.

The processing unit 114 is coupled to the detecting module 112 and the virtual storage interface 113. When the processing unit 114 performs data transmission with the external apparatus 120 via the first transmission path, after the detecting module 112 generates the state change signal, the processing unit 114 stores the follow-up data that is to be transmitted to the external apparatus 120 temporarily in the virtual storage interface 113 and then, after the second transmission path is established, transmits the data temporarily stored in the virtual storage interface 113 to the external apparatus 120 via the second transmission path, so as to continue the data transmission with the external apparatus 120.

One of the first transmission path and the second transmission path is a wired transmission path, and the other one is a wireless transmission path. As shown in FIG. 1B, the electronic apparatus 110 further includes a first wired transmission unit 116 and a first wireless communication unit 117, which are respectively coupled to the processing unit 114. Similarly, the external apparatus 120 further includes a second wired transmission unit 123 and a second wireless communication unit 124. Accordingly, the wired transmission path is established between the first wired transmission unit 116 and the second wired transmission unit 123, and the wireless transmission path is established between the first wireless communication unit 117 and the second wireless communication unit 124.

One of the first wired transmission unit 116 and the second wired transmission unit 123 is a male connector of a data bus, and the other one is a female connector of the data bus, for example. The aforementioned data bus includes a universal serial bus (USB), IEEE 1394, etc. The first wireless communication unit 117 and the second wireless communication unit 124 are infra-red circuit, Bluetooth, Wi-Fi circuit, near-field communication (NFC) circuit, etc., for example. It should be noted that the foregoing are examples and should not be construed as a limitation to the invention.

The processing unit 114 may be hardware having operation and processing capabilities (such as chip set, processor, etc.), software component (such as operation system, application, etc.), or a combination thereof. For example, the processing unit 114 may be a central processing unit (CPU), a programmable microprocessor, a digital signal processor (DSP), a programmable controller, an application specific integrated circuit (ASIC), a programmable logic device (PLD), or the like.

Additionally, the external apparatus 120 includes the storage unit 122 for storing the data received from the electronic apparatus 110. That is, the external apparatus 120 provides a storage space for the electronic apparatus 110. The storage unit 122 is, for example, a component capable of storing data, such as a hard disc, disc, solid state drive, flash memory, etc.

In other embodiments, another trigger component may also be disposed in the external apparatus 120. This trigger component is similar to the trigger component 115 and thus will not be described in detail hereinafter. Otherwise, the trigger component 115 may be disposed in the external apparatus 120. In addition, another detecting module may be disposed in the external apparatus 120 to perform the same function as the detecting module 112 of the electronic apparatus 110.

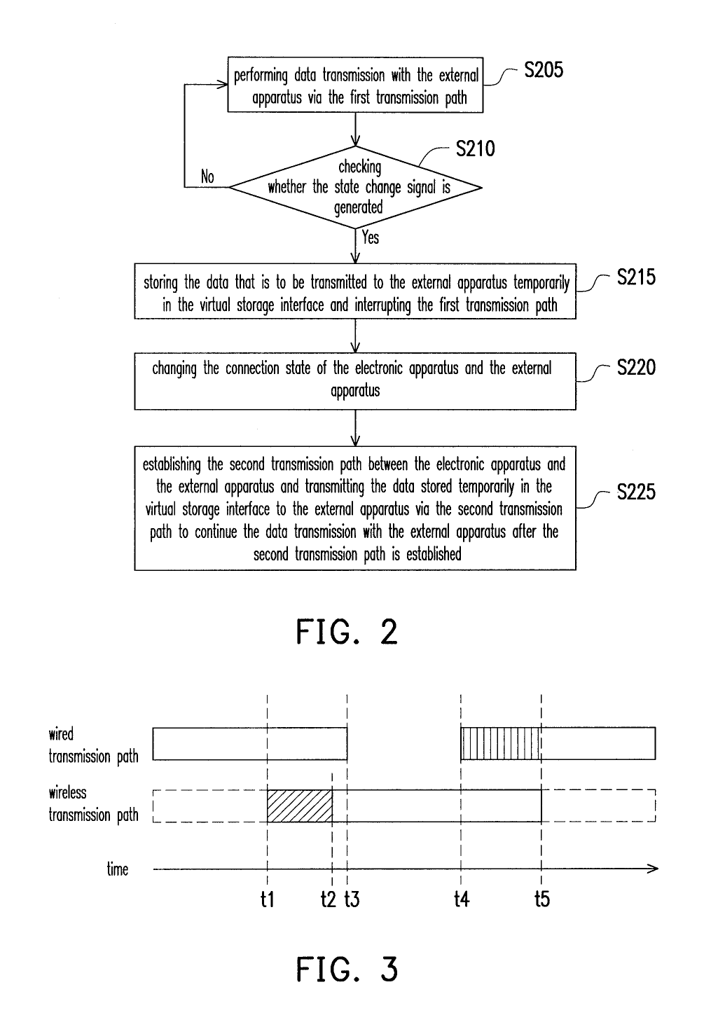

Steps of a data transmission method are further explained below based on the aforementioned data transmission system 100. FIG. 2 is a flowchart illustrating the data transmission method according to the first embodiment of the invention. In this embodiment, the data transmission method is applied to the electronic apparatus 110.

Referring to FIG. 1A and FIG. 2, in Step S205, the electronic apparatus 110 performs data transmission with the external apparatus 120 via the first transmission path. The first transmission path may be a wired transmission path or a wireless transmission path. For instance, when the electronic apparatus 110 is connected with the external apparatus 120 (coupling state), the processing unit 114 performs data transmission with the external apparatus 120 via the wired transmission path. Furthermore, when the electronic apparatus 110 is separated from the external apparatus 120 (detaching state), the processing unit 114 performs data transmission with the external apparatus 120 via the wireless transmission path.

Next, in Step S210, the electronic apparatus 110 checks whether the state change signal is generated, so as to determine whether the connection state of the electronic apparatus 110 and the external apparatus 120 is about to change (for example, switch to the coupling state or the detaching state). For example, provided that the electronic apparatus 110 and the external apparatus 120 are in the coupling state, the detecting module 112 detects whether the connection state of the electronic apparatus 110 and the external apparatus 120 is to be switched to the detaching state. On the other hand, provided that the electronic apparatus 110 and the external apparatus 120 are in the detaching state, the detecting module 112 detects whether the connection state of the electronic apparatus 110 and the external apparatus 120 is to be switched to the coupling state. When the detecting module 112 detects that the connection state is about to change, the detecting module 112 generates the state change signal and transmits the state change signal to the processing unit 114. According to different designs of the product, the connection state of the electronic apparatus 110 and the external apparatus 120 may be changed by a fixture component therebetween, wherein the fixture component may be a hook driven by a motor, an ejection element configured on the external apparatus, a hook using an elastic element, etc.; however, the scope of the invention is not limited thereto.

After the state change signal is generated, in Step S215, the electronic apparatus 110 stores the follow-up data that is to be transmitted to the external apparatus 120 temporarily in the virtual storage interface 113 and interrupts the first transmission path. At the moment, the electronic apparatus 110 and the external apparatus 120 are not separated yet. For example, when the user integrates or separates the electronic apparatus 110 and the external apparatus 120, the trigger component 115 is enabled first, and at the same time, the detecting module 112 generates the state change signal. After that, the user completely integrates or separates the electronic apparatus 110 and the external apparatus 120 to change the connection state of the electronic apparatus 110 and the external apparatus 120.

Moreover, in Step S220, the processing unit 114 changes the connection state of the electronic apparatus 110 and the external apparatus 120. Then, in Step S225, the processing unit 114 drives the related components to establish the second transmission path between the electronic apparatus 110 and the external apparatus 120. And, after the second transmission path is established, the data stored temporarily in the virtual storage interface 113 is transmitted to the external apparatus 120 via the second transmission path, so as to continue the data transmission with the external apparatus 120. In this embodiment, the virtual storage interface 113 is disposed in the electronic apparatus 110 for temporarily storing the data that is to be transmitted to the external apparatus 120 when the state change signal is generated. The steps are to make the processing unit 114 store the data temporarily in the virtual storage interface 113 before the second transmission path is established, so as to maintain the data transmission in a connection state, for the processing unit 114 to immediately resume transmitting the data stored in the virtual storage interface 113 to the external apparatus 120 after the second transmission path is established.

According to the aforementioned method, in the case that the electronic apparatus 110 is inserted on the external apparatus 120 and transmitting data to the external apparatus 120, the electronic apparatus 110 temporarily stores the data beforehand when the electronic apparatus 110 is to be detached from the external apparatus 120 but not completely separated. For instance, an interrupt message is sent to the wired transmission path that is transmitting the data to shut down the wired transmission path, such that the data is temporarily kept in the virtual storage interface 113. Then, when the wireless transmission path is established, the temporarily stored data is automatically transmitted to the external apparatus 120 so as to resume the data transmission.

With the aforementioned method and the special design of the hardware (i.e. use of the trigger component 115 and the detecting module 112), detachment of the electronic apparatus 110 from the external apparatus 120 (not separated yet) is detected in advance, such that the step of establishing the wireless transmission path begins before the electronic apparatus 110 is completely separated from the external apparatus 120, thereby preventing data damage due to sudden interruption.

For example, provided that the first connection part 111 and the second connection part 121 are corresponding connectors, and the detecting module 112 includes the detecting pin, when the trigger component 115 is driven and the electronic apparatus 110 is about to be pulled out of the external apparatus 120, the processing unit 114 detects that the two apparatuses may be separated through the detecting pin and starts driving the first wireless communication unit 117 and the second wireless communication unit 124 to establish the wireless transmission path, so as to complete the wireless transmission path in time.

In addition, the detecting module 112 may be used to detect a state that the electronic apparatus 110 is about to be detached from the external apparatus 120, but is disposed back on the external apparatus 120 before separation.

An embodiment is given below to explain the switch between the wired transmission path and the wireless transmission path during plugging. FIG. 3 is a diagram illustrating the switch of transmission paths according to the first embodiment of the invention. Referring to FIG. 1A and FIG. 3, in this embodiment, an initial connection state of the electronic apparatus 110 and the external apparatus 120 is the coupling state. That is to say, at the beginning, the electronic apparatus 110 and the external apparatus 120 perform data transmission via the wired transmission path.

At Time t1, the electronic apparatus 110 is ready to be detached from the external apparatus 120, and accordingly the trigger component 115 is enabled and the detecting module 112 generates the state change signal. At Time t3, the electronic apparatus 110 is completely detached from the external apparatus 120. From Time t1 to Time t2, the electronic apparatus 110 begins establishing the wireless transmission path with the external apparatus 120.

At Time t4 when the electronic apparatus 110 is ready to be integrated back to the external apparatus 120, the trigger component 115 is enabled again and the detecting module 112 generates the state change signal again. At Time t5, the electronic apparatus 110 is completely integrated with the external apparatus 120. From Time t4 to Time t5, the data transmission is performed via the wireless transmission path. And, when the electronic apparatus 110 is completely integrated with the external apparatus 120, which means that the wired transmission path is established, the data transmission is switched to the wired transmission path from Time t5. According to different designs of the product, when the electronic apparatus 110 is integrated with the external apparatus 120, the electronic apparatus 110 may be directly integrated with the external apparatus 120 to cause the detecting module 112 to generate the state change signal without enabling the trigger component 115, but it should be noted that the scope of the invention is not limited thereto.

According to an experiment, a period from Time t1 to Time t3 is less than or equal to 500 milliseconds. In addition, according to the specification of the operation system, Windows 8, the establishment of the wireless transmission path requires about 120 milliseconds or less. That is, a period from Time t1 to Time t2 is less than or equal to 120 milliseconds. Therefore, the wireless transmission path has been established for transmitting data when the electronic apparatus 110 is completely pulled out.

Moreover, before Time t1 or after Time t5, the wireless transmission path may selectively remain in a standby state, so as to be actuated quickly when needed. That is, the wireless transmission path remains in the standby state before Time t1. When it is detected that the connection state is about to switch from the coupling state to the detaching state (Time t1), the wireless transmission path can be actuated quickly.

In addition, the transmitted data may be a file, document, picture, sound, video, etc. For example, provided that the electronic apparatus 110 and the external apparatus 120 are connected, and the electronic apparatus 110 is transmitting a picture to the external apparatus 120, when the electronic apparatus 110 is detached from the external apparatus 120, the picture is temporarily stored in the virtual storage interface 113 of the electronic apparatus 110 in a phase from the enabling of the trigger component 115 to the detachment of the electronic apparatus 110. After the electronic apparatus 110 is detached, the picture stored in the virtual storage interface 113 is transmitted to the external apparatus 120 via the wireless transmission path, and following that, the follow-up pictures are transmitted.

Furthermore, provided that the external apparatus 120 is a loudspeaker, and the electronic apparatus 110 is connected with the external apparatus 120 and transmitting a sound to the external apparatus 120 via the wired transmission path, the electronic apparatus 110 switches to transmit the sound to the external apparatus 120 via the wireless transmission path when the electronic apparatus 110 and the external apparatus 120 are separated.

Accordingly, the external apparatus 120 is also capable of executing the same method in other embodiments.

According to different designs of the product, when the electronic apparatus 110 is transmitting data to the external apparatus 120 via the wireless transmission path and is about to switch to the wired transmission path, the transmission path of the data may be switched after the connection state of the electronic apparatus 110 and the external apparatus 120 is changed. When the electronic apparatus 110 and the external apparatus 120 perform data transmission via the wireless transmission path, the electronic apparatus 110 checks whether the state change signal is generated, so as to determine whether the connection state of the electronic apparatus 110 and the external apparatus 120 is about to change. When the electronic apparatus 110 detects the generation of the state change signal, the connection state of the electronic apparatus 110 and the external apparatus 120 will be changed. Thereafter, the electronic apparatus 110 begins establishing the wired transmission path with the external apparatus 120. After the wired transmission path is established, the electronic apparatus 110 interrupts the wireless transmission path and stores the follow-up data that is to be transmitted to the external apparatus 120 temporarily in the virtual storage interface 113. Finally, the electronic apparatus 110 utilizes the wired transmission path to transmit the data stored temporarily in the virtual storage interface 113 to the external apparatus 120 and continues the data transmission with the external apparatus 120. When the electronic apparatus 110 and the external apparatus 120 perform wired transmission, the wireless transmission path is shut down. In other words, wireless signal emitting components (e.g. the first wireless communication unit 117 and the second wireless communication unit 124) on the electronic apparatus 110 and the external apparatus 120 are closed to save power.

Based on the above, when the electronic apparatus 110 accesses the data of the external apparatus 120, the access operation or the accessed data would not be lost or damaged due to the separation or integration of the electronic apparatus 110 and the external apparatus 120.

### Second Embodiment

This embodiment is one of the applications of the first embodiment.

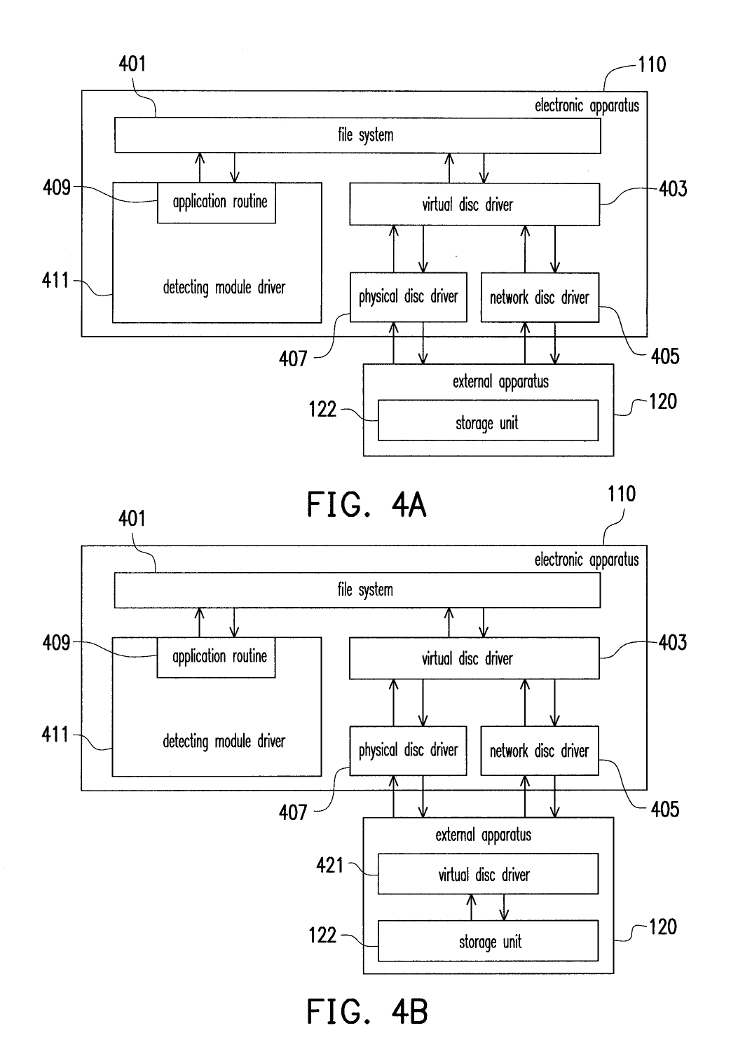

FIG. 4A and FIG. 4B are block diagrams illustrating a data transmission system according to the second embodiment of the invention. Referring to FIG. 4A and FIG. 4B, a software structure in the electronic apparatus 110 includes a file system 401 (in the operation system), a virtual disc driver 403, a network disc driver 405, a physical disc driver 407, and a detecting module driver 411 having an application routine 409. The application routine 409 is an interrupt handler or a polling routine, for example.

In FIG. 4A, the external apparatus 120 includes the storage unit 122. In FIG. 4B, the external apparatus 120 includes the storage unit 122 and the virtual disc driver 421. An operation inside the electronic apparatus 110 when the state change signal is generated and the steps for the electronic apparatus 110 to request access to the external apparatus 120 are further explained in detail below based on the aforementioned structure.

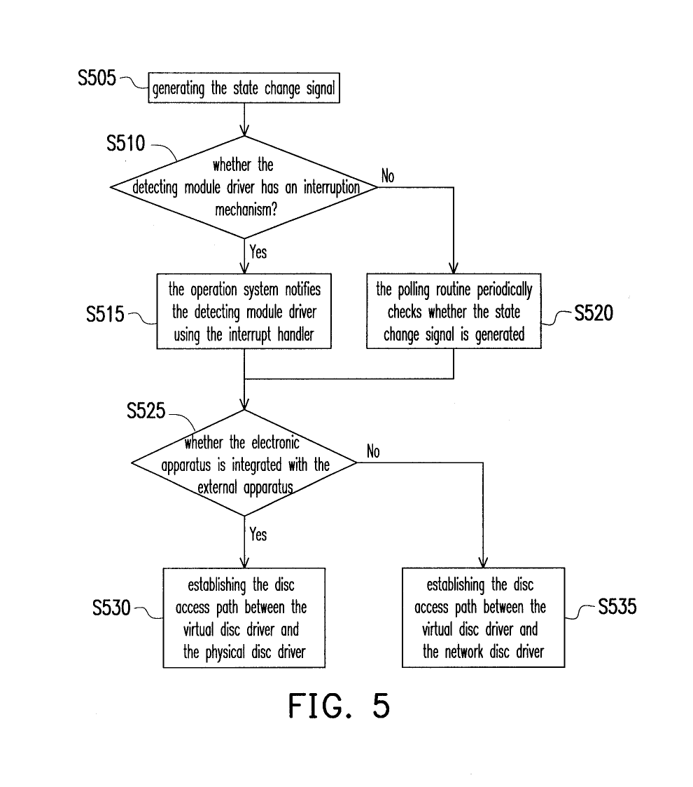

FIG. 5 is a flowchart illustrating an internal operation of the electronic apparatus when the state change signal is generated according to the second embodiment of the invention. Referring to FIG. 1A, FIG. 4A, and FIG. 5 at the same time, when the trigger component 115 is enabled, as shown in Step S505, the detecting module 112 generates the state change signal. Then, Step S510 is carried out to determine whether the detecting module driver 411 has an interruption mechanism.

That is to say, Step S515 is executed if the application routine 409 of the detecting module driver 411 is the interrupt handler; and Step S520 is executed if the application routine 409 of the detecting module driver 411 is the polling routine.

In Step S515, the operation system utilizes the interrupt handler (the application routine 409) to send a message indicating the generation of the state change signal to the detecting module driver 411. That is, the file system 401 generates an interrupt signal through the interrupt handler to notify the detecting module driver 411.

In addition, in Step S520, the detecting module driver 411 utilizes the polling routine (the application routine 409) to periodically check whether the state change signal is generated. That is, the polling routine polls whether the file system 401 has the state change signal recorded therein at intervals.

After Step S515 or Step S520, Step S525 is executed to determine whether the electronic apparatus 110 is integrated with the external apparatus 120. The integration or separation of the electronic apparatus 110 and the external apparatus 120 has been specified in the first embodiment and thus will not be described hereinafter.

If the electronic apparatus 110 and the external apparatus 120 are in the coupling state, a disc access path is established between the virtual disc driver 403 and the physical disc driver 407 in Step S530. Accordingly, the storage unit 122 of the external apparatus 120 is accessed through the physical disc driver 407.

If the electronic apparatus 110 and the external apparatus 120 are in the detaching state, the disc access path is established between the virtual disc driver 403 and the network disc driver 405 in Step S535. Accordingly, the storage unit 122 of the external apparatus 120 is accessed through the network disc driver 405. Furthermore, if the connection state is switched from the coupling state to the detaching state, the follow-up data that is to be transmitted to the external apparatus 120 is temporarily stored in the virtual storage interface 113 through the virtual disc driver 403.

In addition, as shown in FIG. 4B, a virtual disc driver 421 may be disposed in the external apparatus 120 for temporarily storing the data in another virtual storage interface in the external apparatus 120 when the external apparatus 120 transmits the data to the electronic apparatus 110 (or other apparatuses) and the connection state changes from the coupling state to the detaching state. And, the stored data is transmitted after the wireless transmission path is established. The another virtual storage interface in the external apparatus 120 is also divided from a physical storage block (e.g. the storage unit 122).

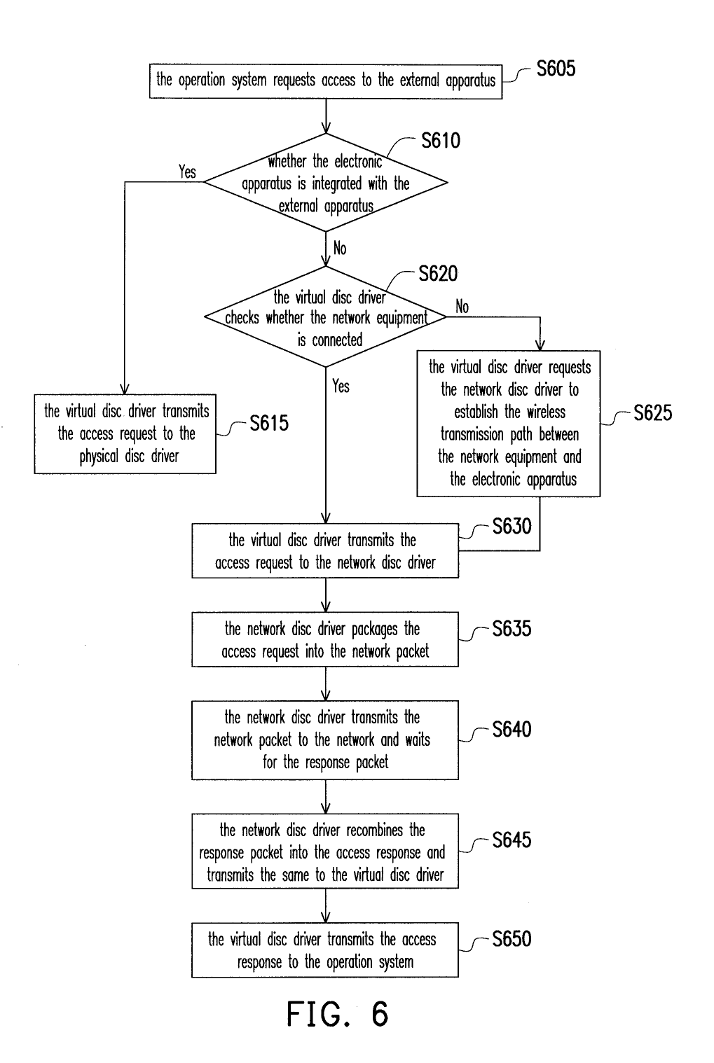

FIG. 6 is a flowchart illustrating a method for the electronic apparatus to request access to an external apparatus according to the second embodiment of the invention. Referring to FIG. 1A, FIG. 4A, and FIG. 6, in Step S605, the operation system requests access to the external apparatus 120. That is, the file system 401 sends an access request to the virtual disc driver 403.

Then, Step S610 is executed to determine whether the electronic apparatus 110 is integrated with the external apparatus 120. The integration or separation of the electronic apparatus 110 and the external apparatus 120 has been specified in the first embodiment and thus will not be described hereinafter.

If the electronic apparatus 110 and the external apparatus 120 are integrated, the virtual disc driver 403 transmits the access request to the physical disc driver 407 and accesses the storage unit 122 of the external apparatus 120 through the physical disc driver 407 in Step S615.

If the electronic apparatus 110 and the external apparatus 120 are separated from each other, the virtual disc driver 403 requests the network disc driver 405 to establish the wireless transmission path between network equipment (not shown) and the electronic apparatus 110 in Step S625. The network equipment is an access point (AP), for example.

Next, in Step S630, the virtual disc driver 403 transmits the access request to the network disc driver 405. Moreover, in Step S635, the network disc driver 405 packages the access request into a network packet. In Step S640, the network disc driver 405 transmits the network packet to a network and waits for a response packet.

Thereafter, in Step S645, the network disc driver 405 recombines the response packet into an access response and transmits the access response to the virtual disc driver 403. Following that, in Step S650, the virtual disc driver 403 transmits the access response back to the file system 401 of the operation system.

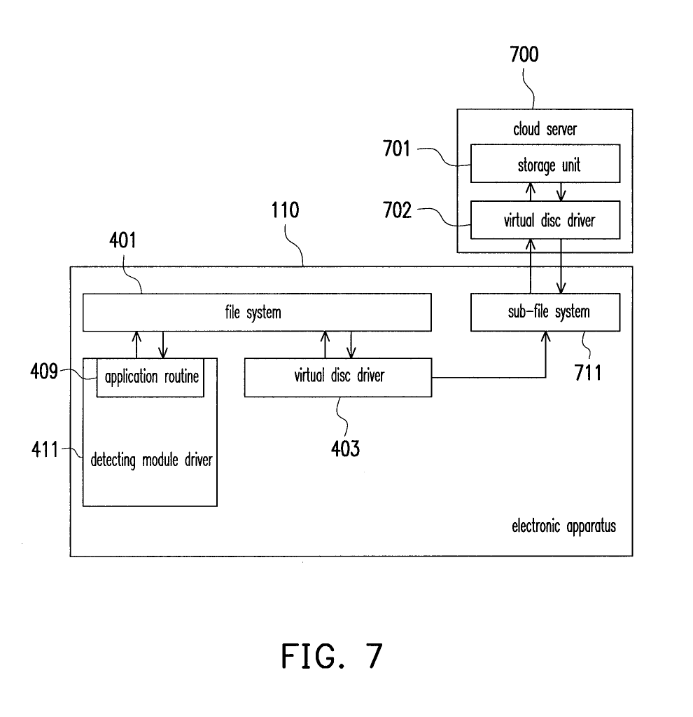

FIG. 7 is a block diagram illustrating the electronic apparatus and a cloud server according to the second embodiment of the invention. In this embodiment, a cloud server 700 may substitute for the external apparatus 120, for example. In addition, the electronic apparatus 110 further includes a sub-file system 711 for communicating with a virtual disc driver 702 of the cloud server 700, so as to access a storage unit 701 of the cloud server 700.

### Third Embodiment

This embodiment is one of the applications of the first embodiment.

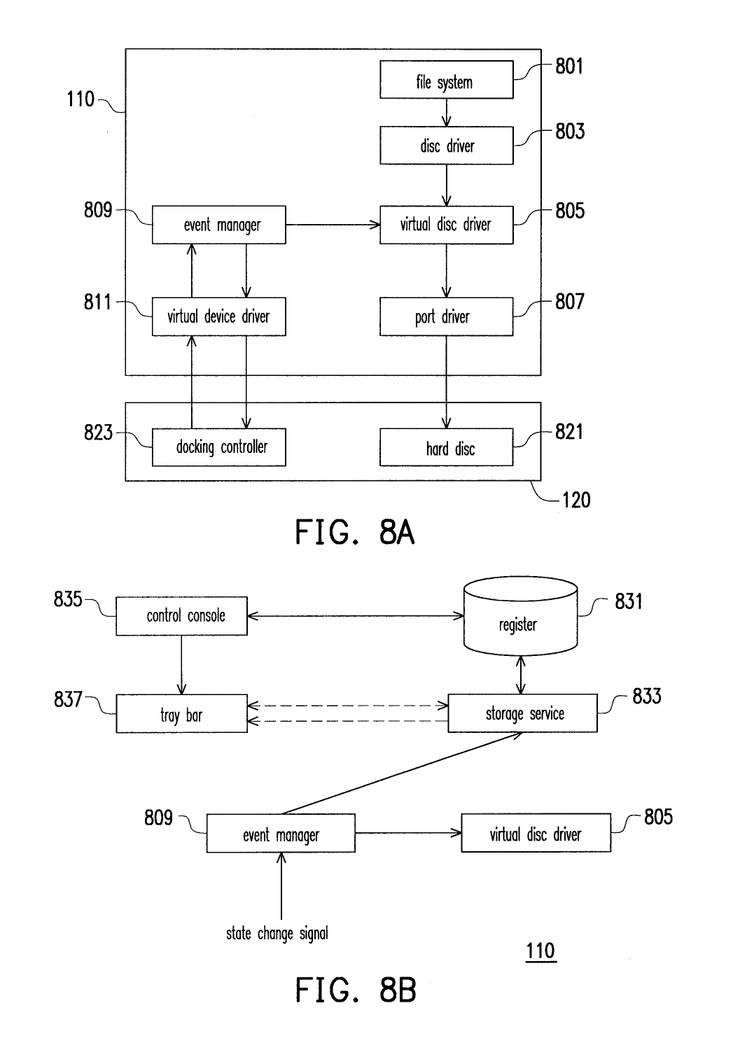

FIG. 8A is a block diagram illustrating a data transmission system according to the third embodiment of the invention. FIG. 8B is a diagram illustrating a structure of the electronic apparatus from a perspective of the user according to the third embodiment of the invention.

Referring to FIG. 8A, the external apparatus 120 is a docking, for example, including a hard disc 821 (an embodiment of the storage unit 122 in the first embodiment) and a docking controller 823. The electronic apparatus 110 includes a file system 801, a disc driver 803, a virtual disc driver 805, a port driver 807, an event manager 809, and a virtual device driver 811.

The disc driver 803 is a system core file, e.g. Disk.sys, for reading the hard disc 821. The port driver 807 is one of the embodiments of the physical disc driver 407 in the second embodiment, which is ATAPI.sys, for example. The virtual device driver 811 is, for example, an Advanced Configuration and Power Interface (ACPI) virtual device driver. The virtual disc driver 805 is the same as the virtual disc driver 403 in the second embodiment and thus will not be described in detail hereinafter.

When the electronic apparatus 110 and the external apparatus 120 are integrated, the virtual device driver 811 receives a message indicating that the current connection state is the coupling state and establishes a virtual device corresponding to the external apparatus 120 in a basic input output system (BIOS). Then, the virtual device driver 811 transmits a notification message to the event manager 809. In addition, the virtual device driver 811 is also responsible for transmitting a command (e.g. an ACPI command) to the docking controller 823 of the external apparatus 120.

When the event manager 809 receives the notification sent by the virtual device driver 811, the event manager 809 transmits a corresponding event (e.g. a docking-connected event) according to the notification to the virtual disc driver 805.

Here, the virtual disc driver 805 communicates with the port driver 807, and the communication with the virtual storage interface (e.g. the virtual storage interface 113 of the first embodiment) is performed through the virtual disc driver 805. Regarding the communication between the virtual disc driver 805 and the port driver 807, please refer to the descriptions about the virtual disc driver 403 and the physical disc driver 407 of the second embodiment.

FIG. 8B illustrates the software structure of the electronic apparatus 110 from the perspective of the user. In FIG. 8B, the electronic apparatus 110 includes the virtual disc driver 805, the event manager 809, a register 831, a storage service 833, a control console 835, and a tray bar 837.

The register 831 stores the connection state of the electronic apparatus 110 and the external apparatus 120. When the event manager 809 receives the state change signal (e.g. a separation notification or integration notification) sent from the detecting module 112 of the first embodiment, for example, the event manager 809 respectively transmits a separation event or an integration event to the virtual disc driver 805 and the storage service 833. That is to say, the connection state of the electronic apparatus 110 and the external apparatus 120 is monitored through the storage service 833. When the storage service 833 receives the state change signal from the event manager 809, the storage service 833 updates the connection state stored in the register 831 accordingly and notifies the control console 835 for the control console 835 to update the tray bar 837 according to the connection state stored in the register 831.

For example, an icon corresponding to the connection state is displayed in the tray bar 837. The storage service 833 modifies the data in the register 831 according to the event sent by the event manager 809 for the control console 835 to control the icon, relating to the connection state, displayed on the tray bar 837.

In addition, details of the virtual disc driver 805 have been specified by the steps of FIG. 5 and FIG. 6, and thus will not be repeated hereinafter.

### Fourth Embodiment

This embodiment is one of the applications of the first embodiment.

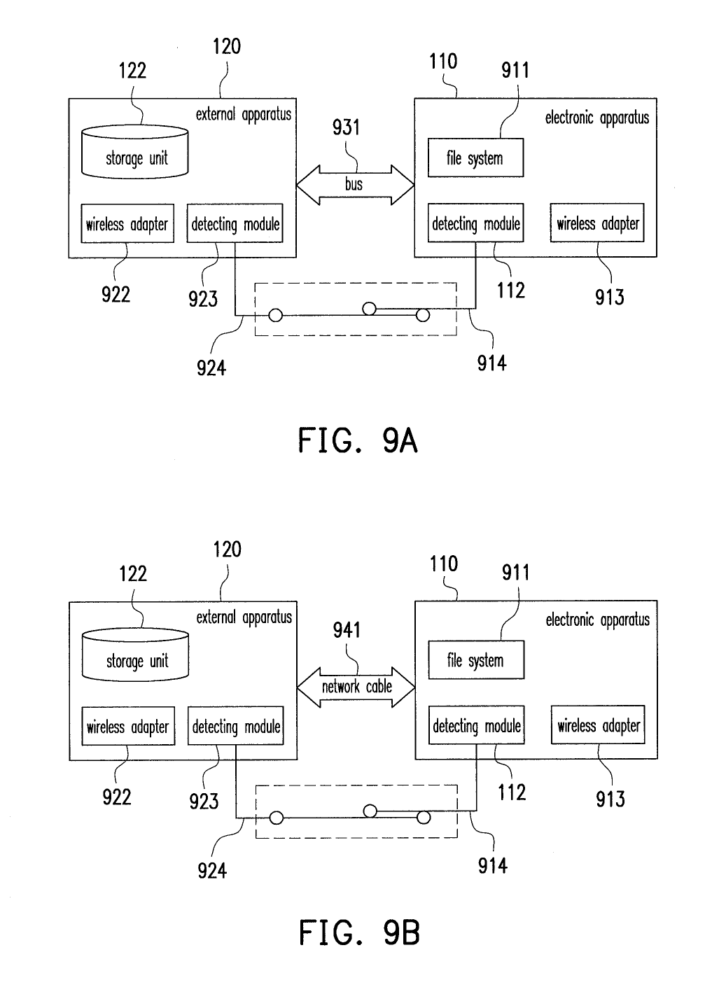

FIG. 9A and FIG. 9B are block diagrams illustrating a data transmission system according to the fourth embodiment of the invention. Referring to FIG. 9A and FIG. 9B, the electronic apparatus 110 includes a file system 911 (in the operation system), the detecting module 112, a wireless adapter 913, and a first connection part 914. The external apparatus 120 includes the storage unit 122, a wireless adapter 922, a detecting module 923, and a second connection part 924. The detecting module 923 performs the same functions as the detecting module 112, which has been specified in the first embodiment. The wireless adapters 913 and 922 are applications of the wireless communication units 117 and 124 of the first embodiment respectively. The connection parts 914 and 924 are applications of the connection parts 111 and 121 of the first embodiment respectively.

In FIG. 9A, the electronic apparatus 110 and the external apparatus 120 perform wired transmission via a bus 931. In FIG. 9B, the electronic apparatus 110 and the external apparatus 120 perform wired transmission via a network cable 941.

In the case that the wireless adapter 913 is in a standby state, the wireless adapter 913 is actuated when the detecting module 112 detects that the connection state is switched from the coupling state to the detaching state. Next, the wireless adapter 913 is connected to the wireless adapter 922. If the wireless adapter 913 is successfully connected to the wireless adapter 922, the file system 911 wirelessly reconnects the wireless transmission path to the external apparatus 120. Then, the file system 911 shuts down the wired transmission path.

However, if the wireless adapter 913 is not successfully connected to the wireless adapter 922, the detecting module 112 determines whether the electronic apparatus 110 is completely detached from the external apparatus 120. If the electronic apparatus 110 is not completely detached, the file system 911 waits for the connection between the wireless adapter 913 and the wireless adapter 922. If the electronic apparatus 110 is completely detached from the external apparatus 120, but the wireless adapter 913 is not yet connected to the wireless adapter 922, the file system 911 first shuts down the wired transmission path and waits for the connection between the wireless adapter 913 and the wireless adapter 922. When the wireless adapter 913 is successfully connected to the wireless adapter 922, the file system 911 wirelessly reconnects the wireless transmission path to the external apparatus 120.

When the detecting module 112 detects that the connection state is switched from the detaching state to the coupling state, the file system 911 waits for the reconnection of the wired bus 931. Then, after the bus 931 is reconnected, the file system 911 reestablishes the wired transmission path to the external apparatus 120.

Moreover, the file system 911 suspends or shuts down the wireless transmission path. Afterwards, the wireless adapter 913 enters the standby state, and the wireless adapter 922 also enters the standby state.

Further, several examples are provided below to explain embodiments of different data transmission systems.

Example 1: The data transmission system is an electronic product with a detachable screen, for example. For example, the electronic apparatus 110 is a display, and the external apparatus 120 is a host terminal having a keyboard. Example 2: The electronic apparatus 110 is a mobile device, and the external apparatus 120 is a docking serving as an external storage apparatus, for example. Example 3: The electronic apparatus 110 is a mobile device, and the external apparatus 120 is a network computer, for example. Example 4: The electronic apparatus 110 is a mobile device, and the external apparatus 120 is a network computer, for example, wherein the electronic apparatus 110 communicates with the external apparatus 120 via network equipment, such as a wireless access point, for example. Example 5: The electronic apparatus 110 is a mobile device, and the external apparatus 120 is a network computer, for example, wherein the electronic apparatus 110 communicates with the external apparatus 120 via a network provider (e.g. network supplier). Example 6: The electronic apparatus 110 is a mobile device, and the external apparatus 120 is a docking, for example, wherein the external apparatus 120 may also communicate with a network computer. However, it should be noted that the above examples are merely a part of the embodiments and should not be construed as limitations to the scope of the invention.

To conclude the above, when the electronic apparatus accesses the data of the external apparatus, the access operation or the accessed data would not be lost or damaged due to the separation or integration of the electronic apparatus and the external apparatus. Specifically, by disposing the virtual storage interface, if separation or integration occurs during access of the data, the data that is being transmitted is temporarily stored in the virtual storage interface. Then, the data transmission is resumed after the wired or the wireless transmission path is established. Thus, the user does not need to restart the data transmission because of the separation or integration of the electronic apparatus and the external apparatus. In addition, the configuration of the detecting module and the trigger component can detect in advance whether the electronic apparatus and the external apparatus are about to be integrated or separated, so as to switch the transmission path in advance.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A data transmission method, for an electronic apparatus detachably coupled to an external apparatus, the data transmission method comprising:
performing a data transmission with the external apparatus via a first transmission path;
checking whether a state change signal is generated to determine whether a connection state of the electronic apparatus and the external apparatus is about to change;
storing data that is to be transmitted to the external apparatus temporarily in a virtual storage interface and interrupting the first transmission path after the state change signal is generated;
changing the connection state of the electronic apparatus and the external apparatus; and
establishing a second transmission path between the electronic apparatus and the external apparatus, and transmitting the data stored temporarily in the virtual storage interface to the external apparatus via the second transmission path to continue the data transmission with the external apparatus after the second transmission path is established.

2. The data transmission method according to claim 1, further comprising:
generating the state change signal through a detecting module when a trigger component is enabled; and
determining whether the connection state is changed according to the state change signal, wherein a change of the connection state refers to a switch from a coupling state to a detaching state or a switch from the detaching state to the coupling state.

3. The data transmission method according to claim 2, further comprising:
the electronic apparatus driving an element that establishes the second transmission path after the trigger component is enabled and the detecting module generates the state change signal.

4. The data transmission method according to claim 1, wherein one of the first transmission path and the second transmission path is a wired transmission path and the other one is a wireless transmission path, and the data transmission method further comprises:
establishing the wired transmission path for the electronic apparatus to perform the data transmission with the external apparatus via the wired transmission path when the connection state is a coupling state; and
establishing the wireless transmission path for the electronic apparatus to perform the data transmission with the external apparatus via the wireless transmission path when the connection state is a detaching state.

5. The data transmission method according to claim 4, wherein, when the connection state is the coupling state, the data transmission method further comprises:
maintaining the wireless transmission path in a standby state; and
actuating the wireless transmission path when detecting that the connection state is about to switch from the coupling state to the detaching state.

6. The data transmission method according to claim 1, further comprising:
storing the data that is to be transmitted to the external apparatus temporarily in the virtual storage interface via a virtual disc driver after the state change signal is generated, wherein the virtual storage interface is divided from a physical storage block.

7. The data transmission method according to claim 1, further comprising:
indicating the connection state in a display interface.

8. The data transmission method according to claim 1, further comprising:
changing the connection state of the electronic apparatus and the external apparatus using a fixture component.

9. A data transmission method, for an electronic apparatus detachably coupled to an external apparatus, the data transmission method comprising:
performing a data transmission with the external apparatus via a wireless transmission path;
checking whether a state change signal is generated to determine whether a connection state of the electronic apparatus and the external apparatus is about to change;
changing the connection state of the electronic apparatus and the external apparatus after the state change signal is generated;
establishing a wired transmission path between the electronic apparatus and the external apparatus;
interrupting the wireless transmission path and storing data that is to be transmitted to the external apparatus temporarily in a virtual storage interface; and
transmitting the data stored temporarily in the virtual storage interface to the external apparatus via the wired transmission path to continue the data transmission with the external apparatus.

10. The data transmission method according to claim 9, further comprising:
storing the data that is to be transmitted to the external apparatus temporarily in the virtual storage interface via a virtual disc driver after the state change signal is generated, wherein the virtual storage interface is divided from a physical storage block.

11. The data transmission method according to claim 9, further comprising:
indicating the connection state in a display interface.

12. An electronic apparatus, comprising:
a connection part detachably coupled to an external apparatus;
a detecting module generating a state change signal responsive to whether a trigger component is enabled to detect whether a connection state of the electronic apparatus and the external apparatus is changed;
a virtual storage interface temporarily storing data that is to be transmitted to the external apparatus; and
a processing unit coupled to the detecting module and the virtual storage interface;
wherein the processing unit performs a data transmission with the external apparatus via a first transmission path, and the processing unit stores the data that is to be transmitted to the external apparatus temporarily in the virtual storage interface when detecting that the state change signal is generated, and the processing unit transmits the data stored temporarily in the virtual storage interface to the external apparatus to continue the data transmission with the external apparatus via a second transmission path after the second transmission path is established with the external apparatus.

13. The electronic apparatus according to claim 12, further comprising:
a wired transmission unit coupled to the processing unit and establishing a wired transmission path when the connection state is a coupling state; and
a wireless communication unit coupled to the processing unit and establishing a wireless transmission path when the connection state is a detaching state;
wherein one of the first transmission path and the second transmission path is the wired transmission path and the other one is the wireless transmission path.

14. The electronic apparatus according to claim 13, wherein the processing unit maintains the wireless transmission path in a standby state when detecting that the connection state is the coupling state, and actuates the wireless transmission path when detecting that the connection state is about to switch from the coupling state to the detaching state.

15. The electronic apparatus according to claim 12, wherein the processing unit stores the data that is to be transmitted to the external apparatus temporarily in the virtual storage interface via a virtual disc driver when the detecting module generates the state change signal, wherein the virtual storage interface is divided from a physical storage block.

16. The electronic apparatus according to claim 12, wherein the processing unit disables the first transmission path when the detecting module generates the state change signal.

17. The electronic apparatus according to claim 12, wherein the connection part is a connector, and the detecting module comprises a detecting pin.

18. The electronic apparatus according to claim 12, wherein the electronic apparatus is one of a tablet computer, a mobile phone, and a smart phone; and the external apparatus is a docking comprising a storage unit.

19. A data transmission system, comprising an electronic apparatus and an external apparatus, wherein the electronic apparatus is detachably coupled to the external apparatus,
the electronic apparatus comprising:
a first connection part;
a detecting module generating a state change signal responsive to whether a trigger component is enabled to detect whether a connection state of the electronic apparatus and the external apparatus is changed;
a virtual storage interface temporarily storing data that is to be transmitted to the external apparatus; and
a processing unit coupled to the detecting module and the virtual storage interface, wherein the processing unit performs a data transmission with the external apparatus via a first transmission path, and the processing unit stores the data that is to be transmitted to the external apparatus temporarily in the virtual storage interface when detecting that the state change signal is generated, and the processing unit transmits the data stored temporarily in the virtual storage interface to the external apparatus to continue the data transmission with the external apparatus via a second transmission path after the second transmission path is established with the external apparatus;
the external apparatus comprising:
a second connection part detachably coupled to the first connection part; and
a storage unit storing the data received from the electronic apparatus.

20. The data transmission system according to claim 19, wherein the electronic apparatus is a host, the external apparatus is a docking, the first connection part and the second connection part are connectors, and the detecting module is a detecting pin.

21. The data transmission system according to claim 19, wherein the external apparatus further comprises a virtual disc driver for temporarily storing the data that is to be transmitted to the electronic apparatus.
